(19) United States
(12) Patent Application Publication
(10) Pub. No.: US 2026/0254317 A1
(43) Pub. Date: Aug. 27, 2026

(54) FLUID ENERGY CONVERSION MECHANISM WITH PASSIVE AND ACTIVE ELEMENTS

(71) Applicant: Mohamed Omer Sharif, Las Vegas, NV (US)

(72) Inventor: Mohamed Omer Sharif, Las Vegas, NV (US)

(21) Appl. No.: 19/343,379

(22) Filed: Sep. 29, 2025

Related U.S. Application Data
(60) Provisional application No. 63/761,863, filed on Feb. 21, 2025.

(51) Int. Cl. H02K 7/18; F03B 17/06; F16D 63/00

(52) U.S. Cl. CPC H02K 7/1823; F03B 17/06; F16D 63/00

(57) ABSTRACT

A fluid energy generation apparatus may include a passive element and an active element. The passive element may comprise at least one fluid collection surface configured to collect and direct fluid flow along a gradually narrowing path to create an accelerated fluid flow. The active element may include a rotatable shaft and a cylindrical chamber surrounding the rotatable shaft. A plurality of inlet vents may be formed in the cylindrical chamber and angled to direct the accelerated fluid flow in a unidirectional pattern around the rotatable shaft. At least one attachment may be coupled to the rotatable shaft and configured to convert kinetic energy from the accelerated fluid flow into rotational motion of the shaft. The passive element may be maintained substantially stationary relative to the active element. The apparatus may collect fluid flow from multiple directions around the active element. A spiral surface may create a funneling effect to accelerate the fluid flow.

### CROSS-REFERENCE TO RELATED APPLICATIONS

This application claims priority to U.S. Provisional Patent Application No. 63/761,863 filed Feb. 21, 2025, the entire contents of which are incorporated herein by reference.

### FIELD

The present disclosure relates to energy conversion mechanisms, and more particularly to mechanisms for converting fluid motion into usable energy.

### BACKGROUND

Current methods of generating energy from fluids in motion have limitations in terms of utility and reliability. The energy generation capacity is often limited by variations in speed and direction of the fluid motion. Traditional fluid energy conversion systems require specific fluid velocities to operate effectively. These systems struggle with inconsistent fluid flows. The systems are highly dependent on fluid direction. The systems have minimum velocity requirements for operation. Existing fluid energy harvesting methods do not effectively utilize fundamental fluid dynamics principles. The methods rely primarily on direct fluid impact. The methods employ simple linear flow patterns. The energy capture efficiency decreases significantly at lower fluid velocities.

Conventional systems lack mechanisms for sustaining consistent energy output. The systems are susceptible to fluctuations in environmental conditions. The energy generation is intermittent due to variable fluid conditions. The systems require specific installation configurations. Current technologies have limited scalability across different applications. The systems are typically designed for specific scales of operation. The technologies are not readily adaptable to different deployment scenarios. The systems often require large-scale installations to achieve viable energy output. Traditional conversion mechanisms exhibit poor efficiency in translating fluid motion to usable energy. The mechanisms experience significant energy losses during conversion. The systems lack integrated acceleration capabilities. The energy transfer process is not optimized for variable fluid conditions.

Therefore, there is a need for an improved mechanism that can generate usable energy from fluid moving in multiple directions and at lower flow rates would provide advantages.

### SUMMARY

The present disclosure provides a fluid energy conversion mechanism includes a passive element for collecting and directing fluid flow and an active element for converting the directed fluid flow into rotational mechanical energy. The passive element may include one or more surfaces arranged to create a funneling effect that accelerates the fluid flow. The active element may include a rotating shaft with attachments configured to convert the accelerated fluid flow into rotational motion.

In one aspect, a fluid energy generation apparatus may include a passive element comprising at least one fluid collection surface configured to collect and direct fluid flow along a gradually narrowing path to create an accelerated fluid flow. The apparatus may include an active element comprising a rotatable shaft. The active element may include a cylindrical chamber surrounding the rotatable shaft. The active element may include a plurality of inlet vents formed in the cylindrical chamber and angled to direct the accelerated fluid flow in a unidirectional pattern around the rotatable shaft. The active element may include at least one attachment coupled to the rotatable shaft and configured to convert kinetic energy from the accelerated fluid flow into rotational motion of the shaft. The passive element may be maintained substantially stationary relative to the active element.

In another aspect, a method of generating energy from fluid flow may include collecting fluid flow using at least one stationary collection surface. The method may include directing the collected fluid flow along a gradually narrowing path to create an accelerated fluid flow. The method may include receiving the accelerated fluid flow through angled inlet vents of a cylindrical chamber. The method may include directing the accelerated fluid flow in a unidirectional pattern around a rotatable shaft within the cylindrical chamber. The method may include converting kinetic energy from the accelerated fluid flow into rotational motion of the shaft using at least one attachment coupled to the shaft. The method may include maintaining the collection surface substantially stationary relative to the shaft during operation.

In yet another aspect, a fluid energy generation system may include a passive fluid collection assembly comprising a plurality of converging surfaces arranged radially around a central axis. Each converging surface may extend from a wider fluid intake end to a narrower fluid output end. The converging surfaces may be configured to accelerate collected fluid flow toward the central axis. The system may include an active energy conversion assembly positioned along the central axis comprising a rotatable shaft extending along the central axis. The active energy conversion assembly may include a cylindrical housing surrounding the rotatable shaft. The active energy conversion assembly may include a plurality of angled inlet ports formed in the cylindrical housing. The inlet ports may be configured to direct accelerated fluid from the converging surfaces tangentially around the rotatable shaft. The active energy conversion assembly may include a spiral blade assembly coupled to and extending radially from the rotatable shaft. The spiral blade assembly may be configured to convert fluid kinetic energy into shaft rotation. The passive fluid collection assembly may maintain a fixed position relative to the active energy conversion assembly during operation.

In a further aspect, a fluid energy generation device may include a passive fluid collector comprising a plurality of curved surfaces extending from a first diameter to a second smaller diameter. The curved surfaces may be configured to create a funneling effect to accelerate fluid flow. The device may include an active energy converter comprising an elongated rotatable shaft. The active energy converter may include a housing surrounding the rotatable shaft. The active energy converter may include a plurality of fluid inlets formed in the housing. The fluid inlets may be oriented to direct accelerated fluid flow from the curved surfaces in a uniform direction around the rotatable shaft. The active energy converter may include a spiral attachment coupled to the rotatable shaft. The spiral attachment may be configured to convert fluid kinetic energy to rotational motion. The spiral attachment may be configured to direct fluid flow longitudinally along the shaft.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are not to be considered limiting of its scope, the disclosure will be described with additional specificity and detail through use of the accompanying drawings.

FIG. 1A shows a top-down cross-sectional view of relative positioning between active and passive elements;

FIG. 1B shows a side cross-sectional view corresponding to FIG. 1A;

FIG. 2A shows a top-down view of a single surface passive element directing fluid flow;

FIG. 2B shows a top-down view of multiple surface passive elements directing fluid flow;

FIG. 3A shows a top-down view of a curved surface passive element configuration;

FIG. 3B shows a top-down view of multiple curved surface passive elements;

FIG. 4A shows a side view of straight and curved passive element configurations;

FIG. 4B shows a side view of enclosed passive element collection units;

FIG. 5A shows a side cross-sectional view of an active element with central shaft;

FIG. 5B shows a top-down cross-sectional view of an active element with central shaft;

FIG. 6A shows a side view of an active element with inlet valves;

FIG. 6B shows a top-down view of an active element with angled inlet valves;

FIG. 7A shows a side view of fluid flow through an active element;

FIG. 7B shows a top-down view of unidirectional fluid flow around a central shaft;

FIG. 8A shows a side view of shaft attachments for an active element;

FIG. 8B shows a top-down view of shaft attachments for an active element;

FIG. 9A shows a side view of spiral attachments for an active element;

FIG. 9B shows a top-down view of spiral attachments for an active element;

FIG. 10A shows a side view of fluid flow with spiral attachments;

FIG. 10B shows a top-down view of fluid flow with spiral attachments;

FIG. 11A shows a side view of mechanical energy transfer configurations;

FIG. 11B shows a side view of rotational energy generation;

FIG. 12A shows a side view of spiral fluid flow along an active element;

FIG. 12B shows a side view of integrated component operation.

FIG. 13 shows an example of a potential configuration utilizing this mechanism for generating wind energy, in which a series of 3 curved passive element structures surround a central cylindrical active element, and where the “+” sign indicates capacity for energy storage.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure is not limited to the particular implementations and examples described herein. Different arrangements, configurations, and methods may be used without departing from the scope of the claimed invention. The components, steps, features, objects, benefits, and advantages described herein are not restrictive and there may be other components, steps, features, objects, benefits, and advantages that are not specifically described herein but still fall within the scope of the claimed invention.

While the description and drawings may illustrate specific components and features, these are provided for illustrative purposes and do not limit the scope of the invention. Various modifications, additions, and alterations may be made to the implementations described herein without departing from the spirit and scope of the disclosure. Features from different implementations may be combined or modified in ways not explicitly described to create new implementations that fall within the scope of the claimed invention.

In an embodiment, a passive element in a fluid-driven energy generation mechanism may collect and direct fluid flow through one or more surfaces. The passive element may include a narrowing path structure that may create a funneling effect. The funneling effect may accelerate incoming fluid motion according to the principle of continuity. The passive element may be arranged in multiple configurations. The passive element may receive fluid from one or more directions around an active element. The passive element may include straight line surfaces. The passive element may alternatively include complex enclosed or open spirals. The passive element may be scaled from handheld size to building size. The passive element may be constructed from various materials including sails scaffolded around the active element, plastic surfaces, metal surfaces, or wood surfaces.

In one or more embodiments, the active element may include a spinning shaft that may be stabilized for high rotational rates. The active element may be constructed from lightweight material having high structural integrity. The active element size may be smaller than the passive element size. The smaller relative size of the active element may increase the likelihood of improved energy generation. The shaft may be mounted directly to an external surface. The shaft may alternatively be connected to a surrounding cylinder. The shaft may alternatively be attached to converging passive element structures. The central shaft may spin freely relative to the passive element structures in at least one direction that may promote energy generation. The central shaft may be chambered by a cylindrical structure. The cylindrical structure may be constructed from materials having high structural integrity. The cylindrical structure may include inlet vents. The inlet vents may allow funneled fluid from passive element components to enter the space surrounding the spinning shaft.

In one or more embodiments, the surfaces of the passive elements may alternatively continue to converge towards one another as they approach the active element. The converging surfaces may form inlets through progressive narrowing and ultimate termination of their walls. The central shaft may alternatively be unchambered. The cylindrical structure may include a longitudinal flow mechanism. The longitudinal flow mechanism may be created by the spiral attachment on the central shaft. The longitudinal flow may enhance fluid movement along the length of the shaft. The enhanced fluid movement may reduce resistance to shaft rotation. The reduced resistance may allow for increased rotational speeds.

In one or more embodiments, the spiral attachment may create a low-pressure system within the active element. The low-pressure system may result from increased fluid flow rates according to Bernoulli's principle. The low-pressure system may enhance fluid recruitment through the passive element. The enhanced fluid recruitment may further accelerate rotation of the active element. The acceleration may continue until reaching an equilibrium state. The longitudinal flow may be optimized by minimizing obstructions at the top and bottom of the active element. The minimal obstructions may allow adequate fluid flow in and out of the space around the spinning shaft. The adequate flow may promote sustained rotation. The sustained rotation may enable consistent energy generation.

In one or more embodiments, the system may include mechanisms for initiating the positive feedback loop. The mechanisms may include external means for initially accelerating the central shaft. The external means may be manual or powered activation methods. The initial acceleration may help establish the target dynamic equilibrium. The established equilibrium may promote self-sustaining operation.

In one or more embodiments, a braking system may be included to control shaft rotation. The braking system may slow or stop the spinning shaft when needed. The braking system may provide safety control. The braking system may enable maintenance operations. The mechanism may be implemented across various scales. The mechanism may range from handheld devices to building-sized installations. The mechanism may serve personal energy needs. The mechanism may support home power requirements. The mechanism may enable industrial-scale energy generation. The mechanism may harness energy from wind, ocean currents, or river flows. Furthermore, the braking mechanism is configured for controlling shaft rotation speed. The braking mechanism may be engaged to slow or stop shaft rotation when needed. The braking mechanism may include mechanical or electromagnetic components. The braking components may be controlled manually or automatically. The shaft may include mechanisms for energy extraction. The energy extraction mechanisms may be located at one or both ends of the shaft. The mechanisms may include electromagnetic generators. The generators may convert rotational motion into electrical energy. The electrical energy may be used directly or stored in batteries.

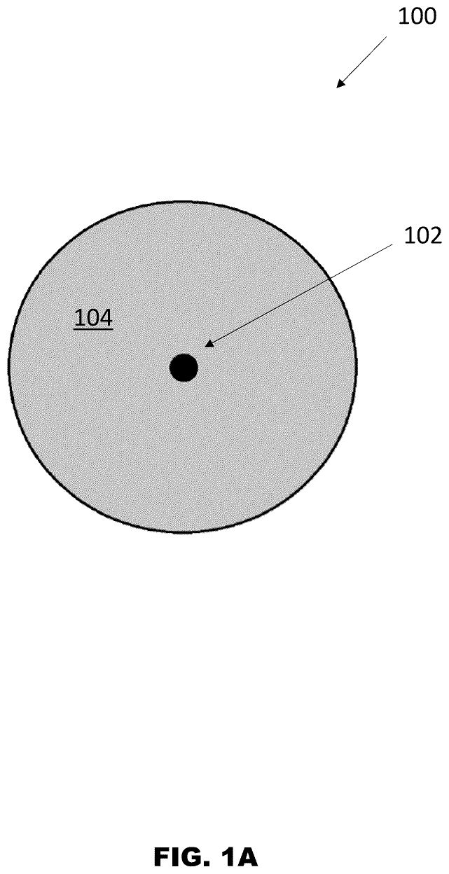

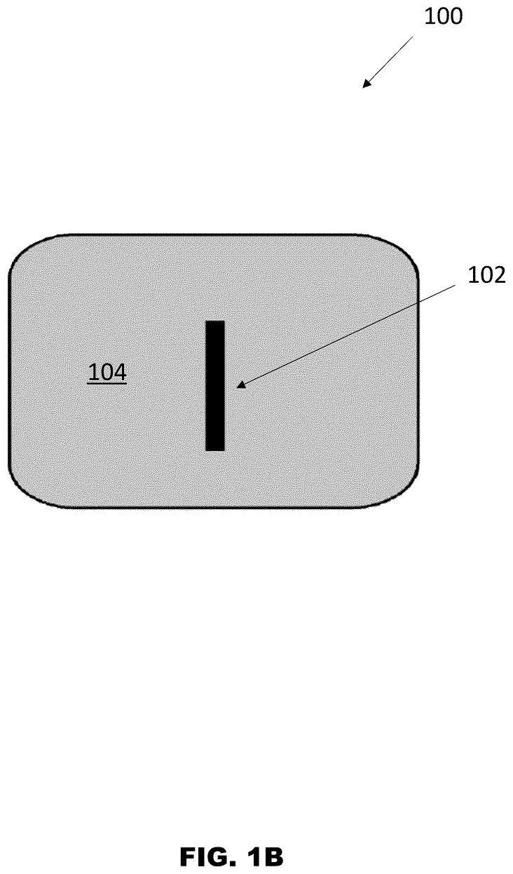

Referring to FIG. 1, a passive element configuration 100 may be shown in both top-down (FIG. 1a) and side (FIG. 1b) cross-sectional views. The active element 102 may be represented by a black circle in the center, while the surrounding gray area 104 may indicate the potential space for passive element placement.

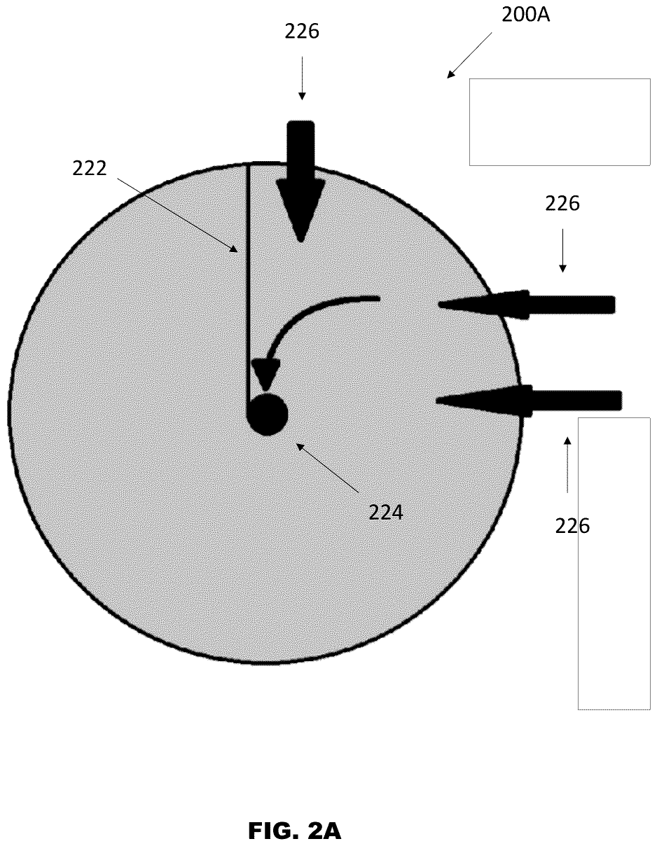

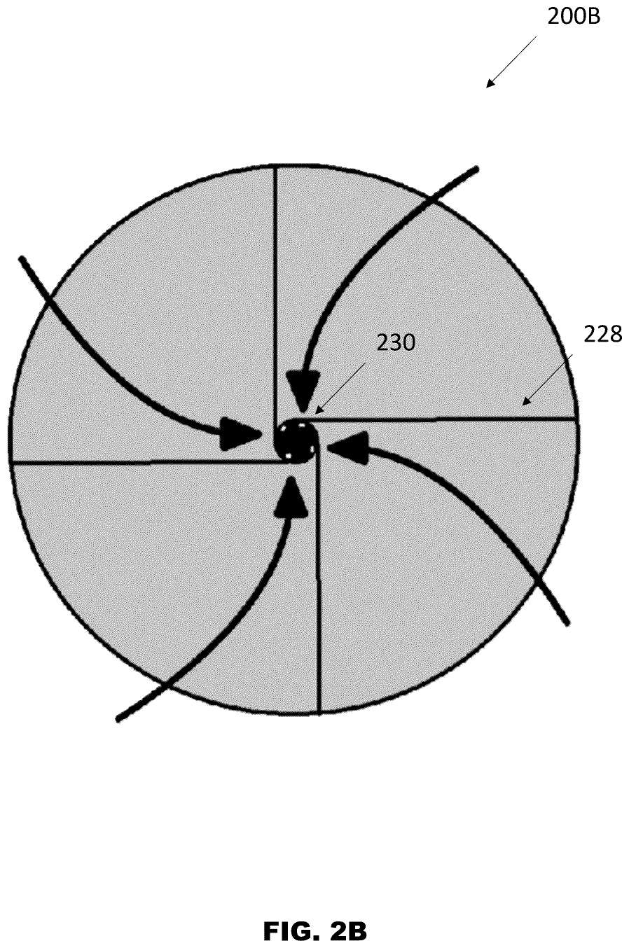

FIG. 2 may demonstrate two passive element configurations. FIG. 2A may show a single surface configuration 200A with a straight line 222 extending from the circumference toward the central active element 224. Black arrows 226 may indicate fluid collection and direction. FIG. 2B may illustrate a multiple surface configuration 200B with four converging lines 228 creating enhanced funneling effects. Small white dots 230 along the active element edges may represent inlet vents.

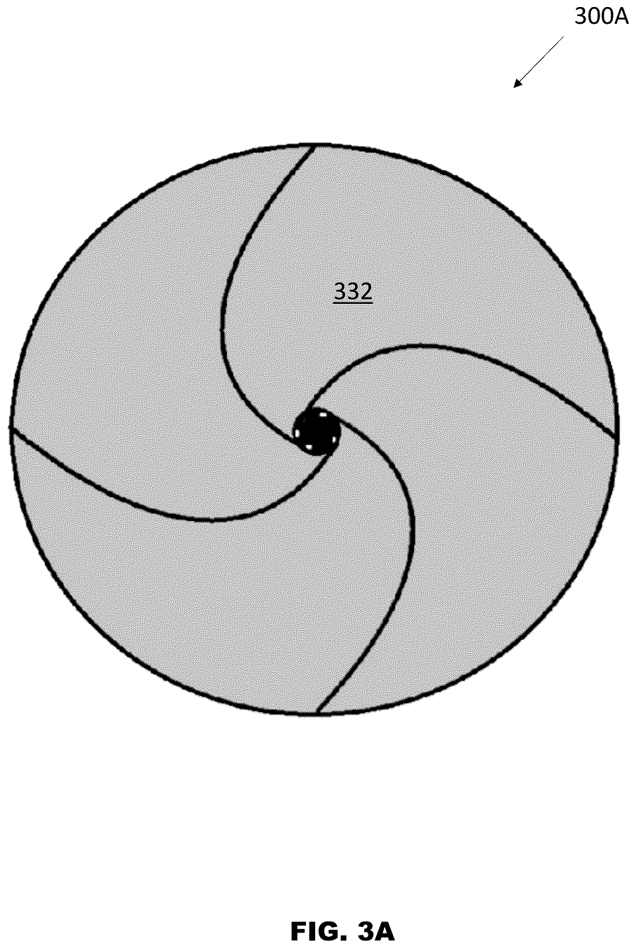

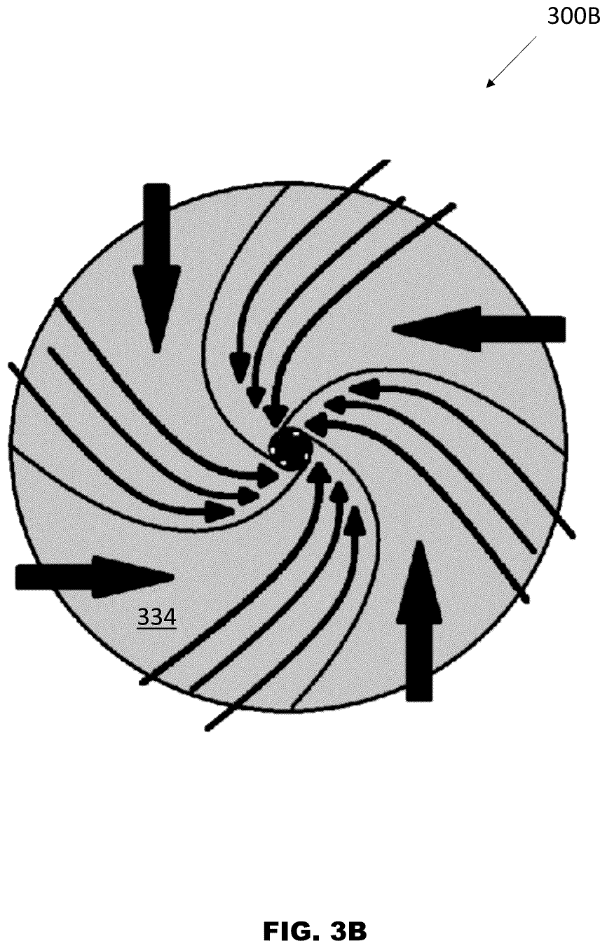

In FIG. 3, curved and spiral surface 300A configurations may be shown. FIG. 3A may demonstrate how a curved surface 332 may enhance fluid harnessing capabilities. FIG. 3B may illustrate multiple curved surfaces 334 converging to enable multidirectional fluid capture.

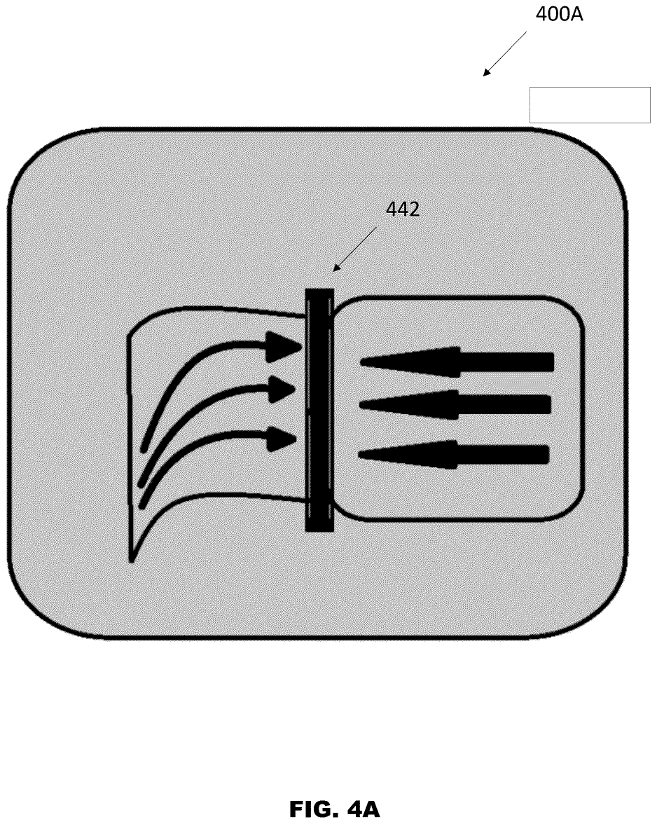

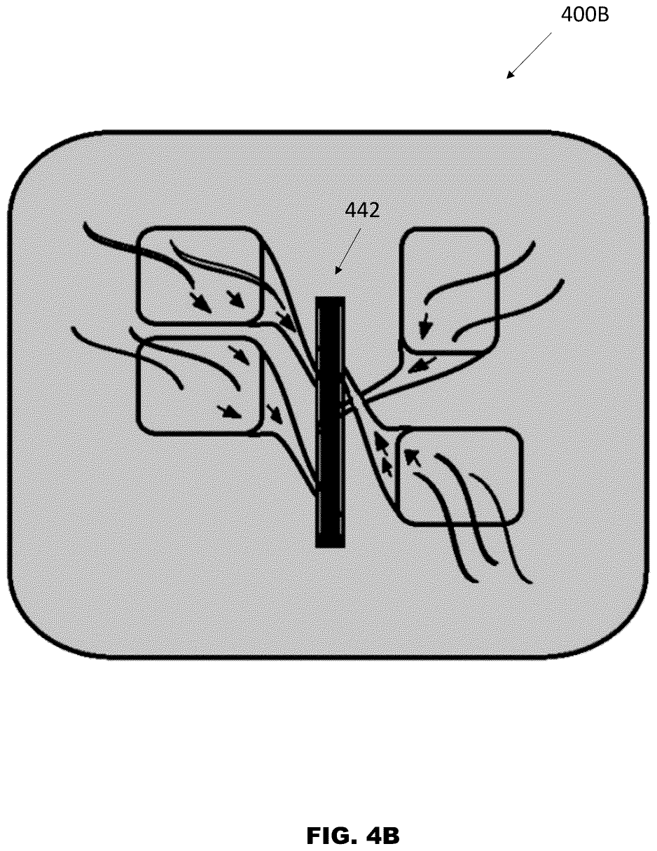

FIG. 4 may present side views of straight (FIG. 4A) and curved (FIG. 4B) passive element designs 400A, 400B directing fluid flow toward the central cylindrical active element 442. White lines along the active element may represent fluid inlets.

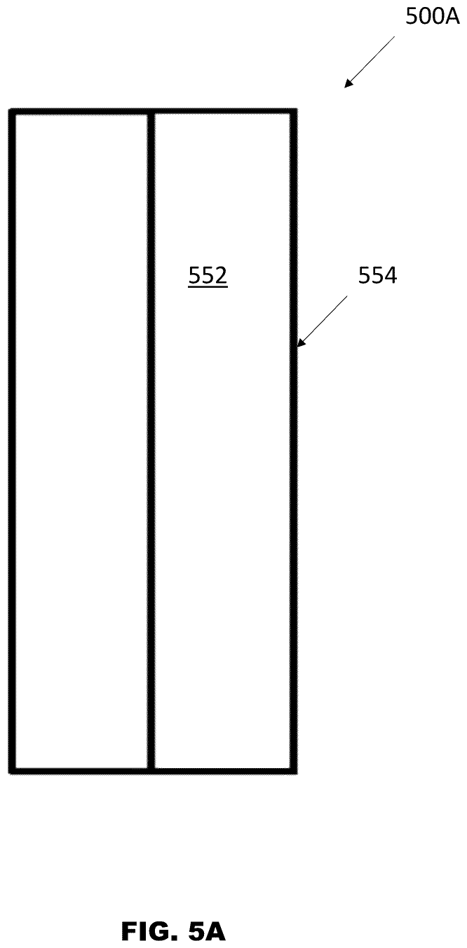

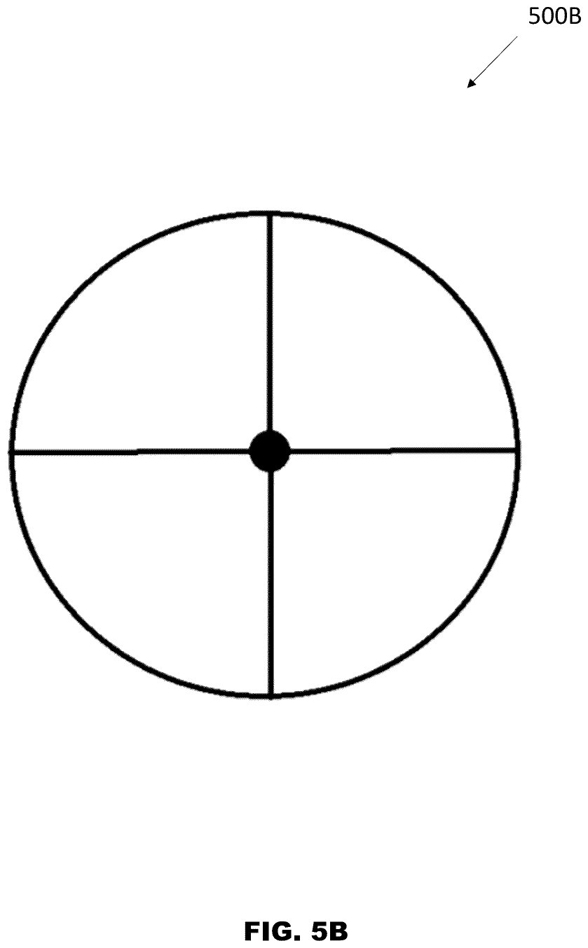

FIG. 5 may provide cross-sectional views of the active element assembly 500A. The side view (FIG. 5A) may show the central shaft 552 within its cylindrical housing 554. The top-down view (FIG. 5B) may illustrate shaft mounting configurations 500B.

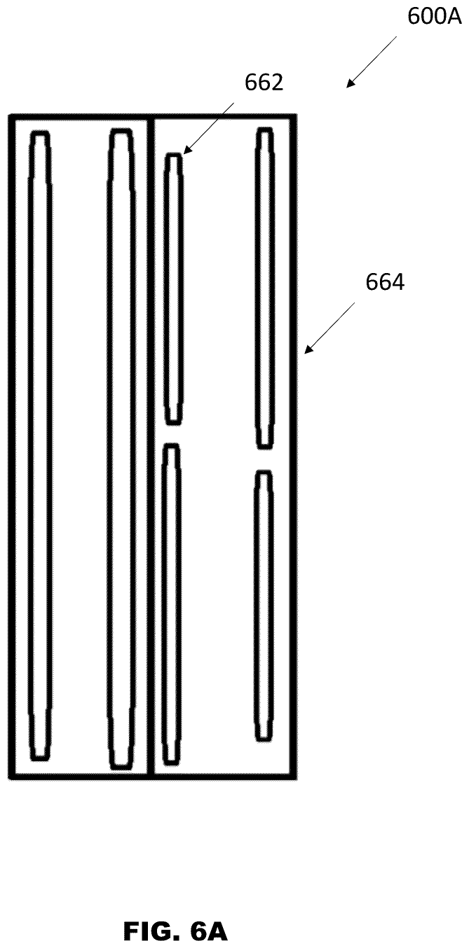

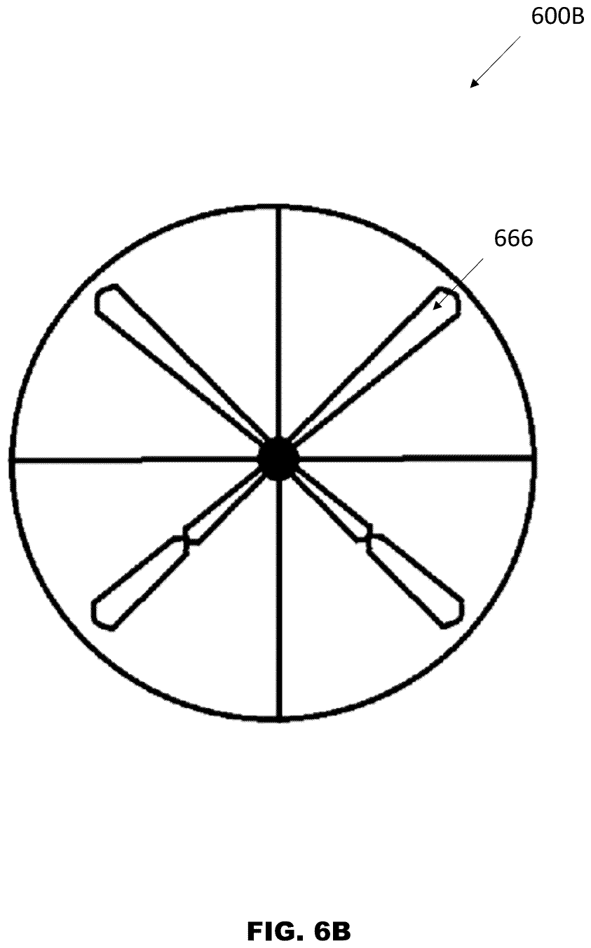

FIG. 6 may detail inlet vent arrangements. The side view (FIG. 6A) 600A may show various sized openings 662 along the cylindrical structure 664. The top view (FIG. 6B) may demonstrate angled inlets 666 creating uniform rotational flow.

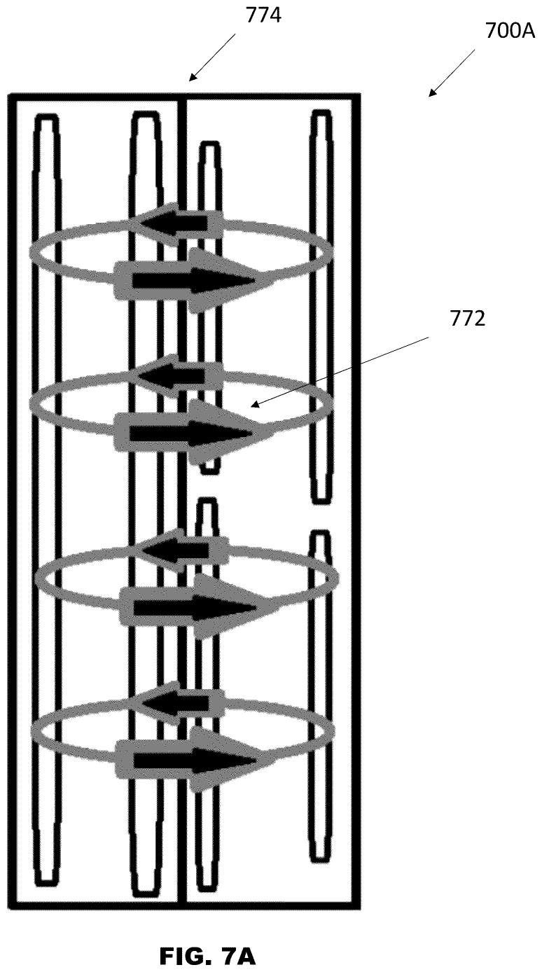

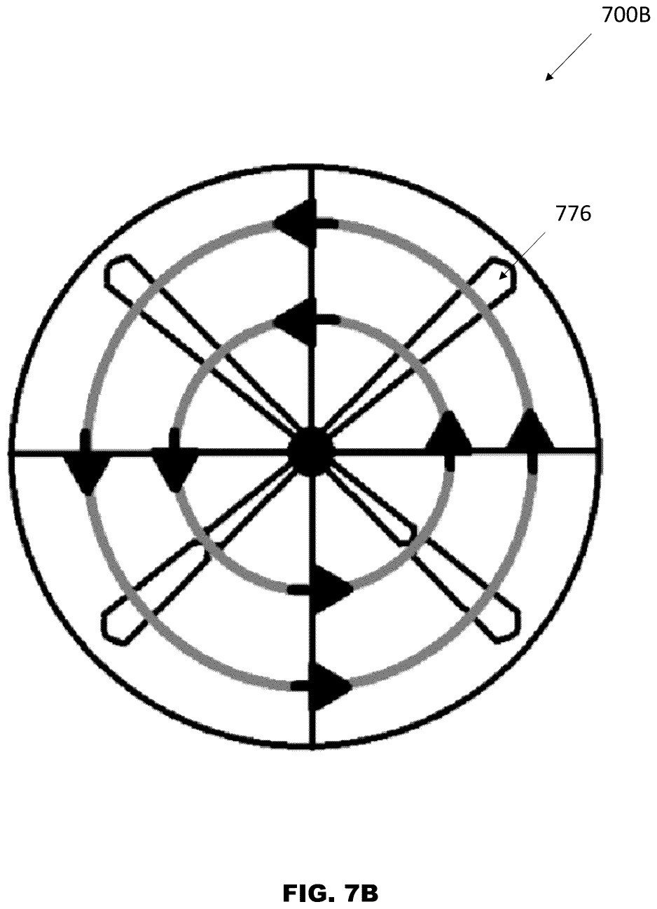

FIG. 7 may focus on fluid flow patterns. Arrows 772 in FIG. 7A may indicate unidirectional rotation around the central shaft 774. FIG. 7B may show how angled inlets 776 may direct fluid consistently.

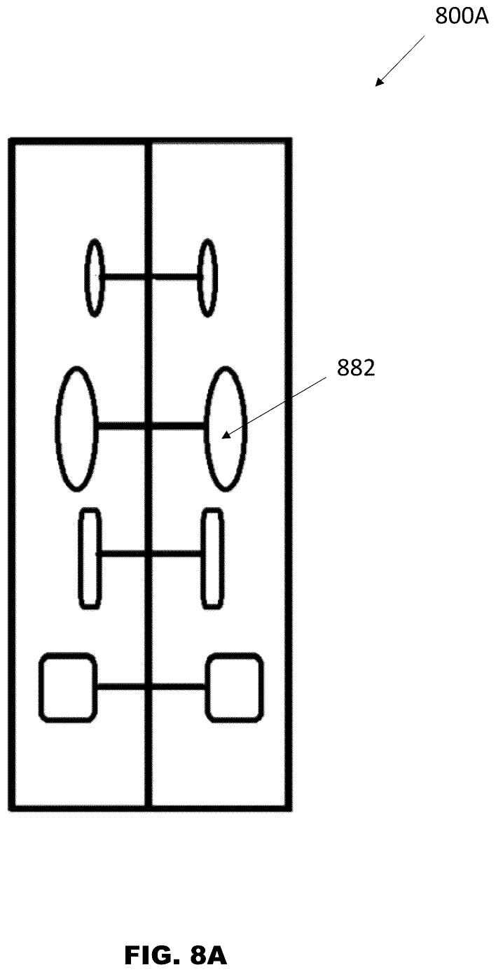

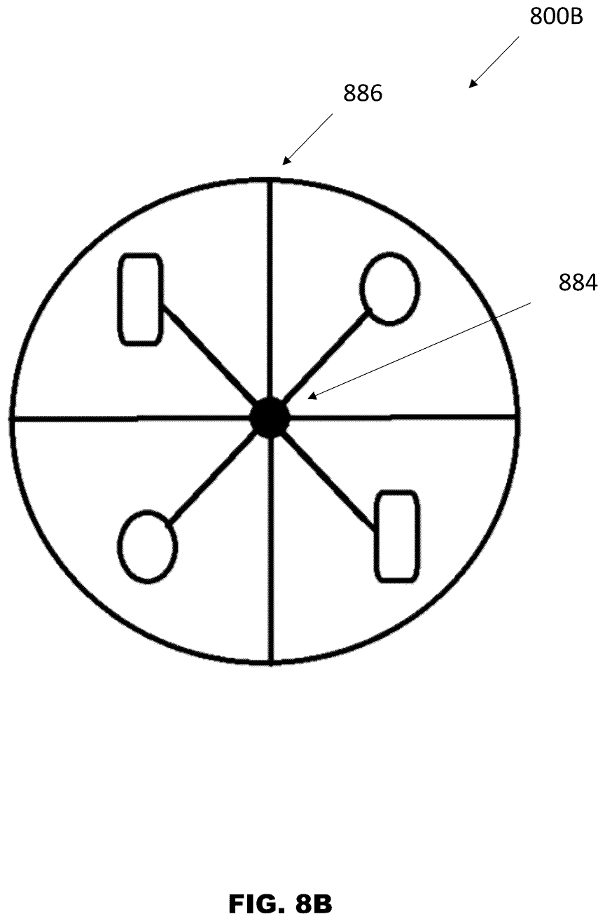

FIG. 8 may illustrate shaft attachment options 800A. FIG. 8A may show different shapes and sizes of attachments 882. FIG. 8B may demonstrate attachment 884 connections to the central shaft 886.

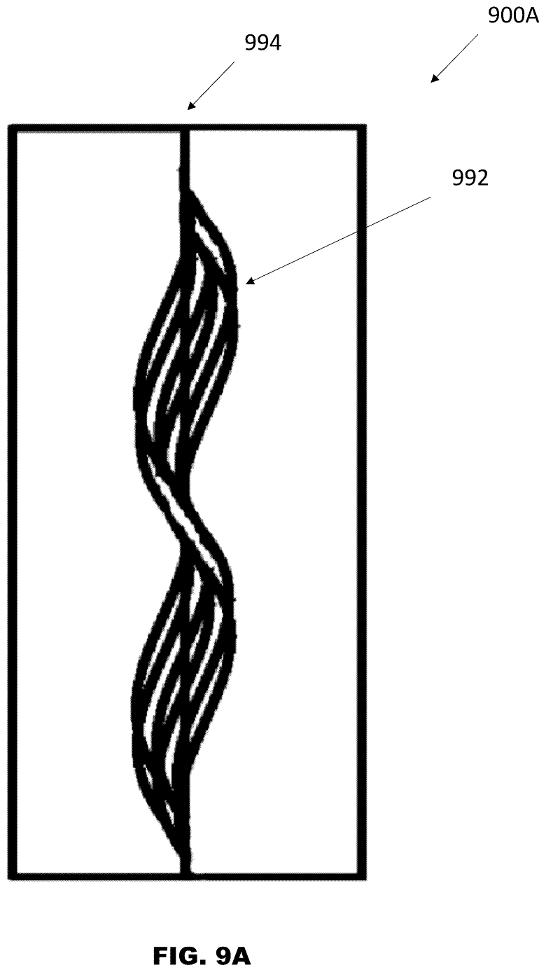

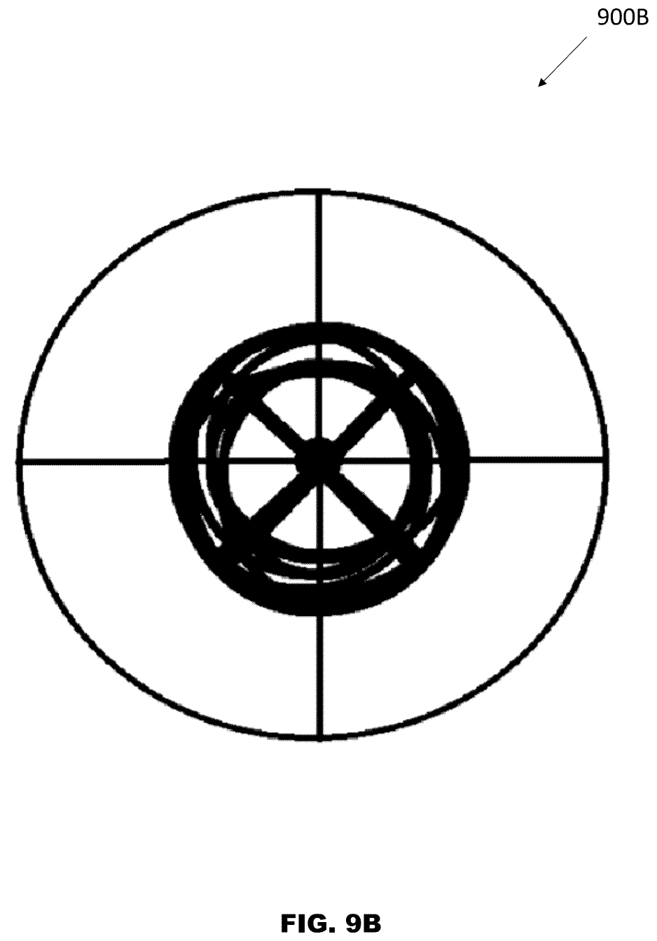

FIG. 9 may present spiral attachment configurations 900A. FIG. 9A may show the spiral 992 form surrounding the central shaft 994. FIG. 9B may illustrate spiral surface attachment methods 900B.

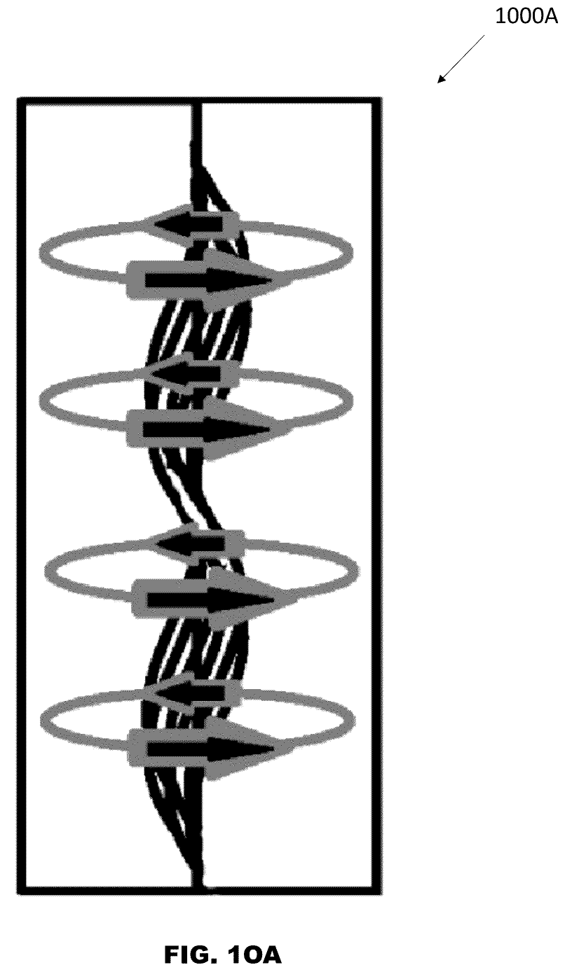

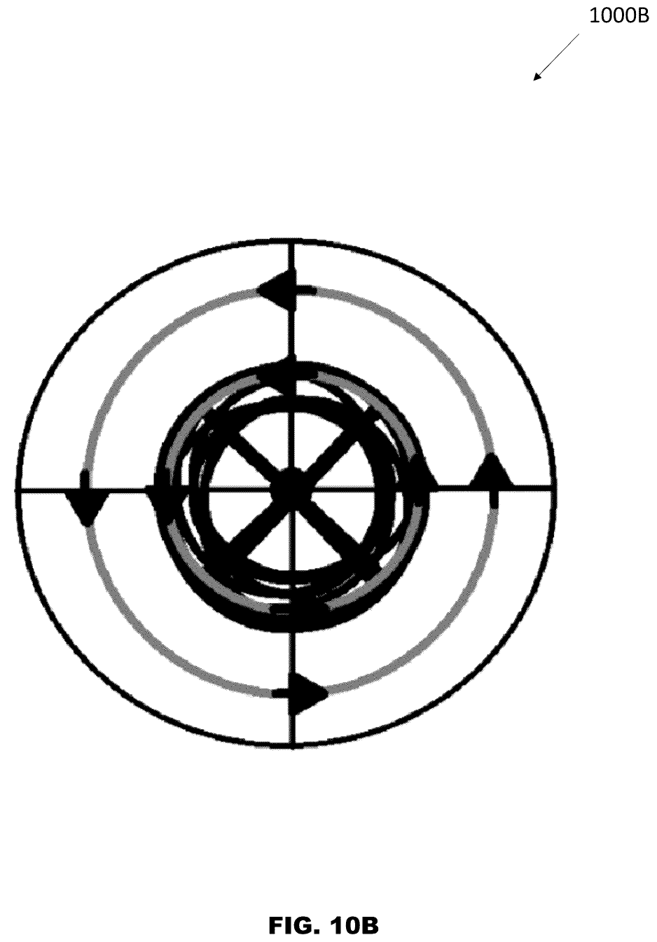

FIG. 10 may demonstrate the operational configuration 1000A. FIG. 10A may show fluid flow interaction 1002 with spiral attachments 1004. FIG. 10B may illustrate resulting rotational patterns 1000B.

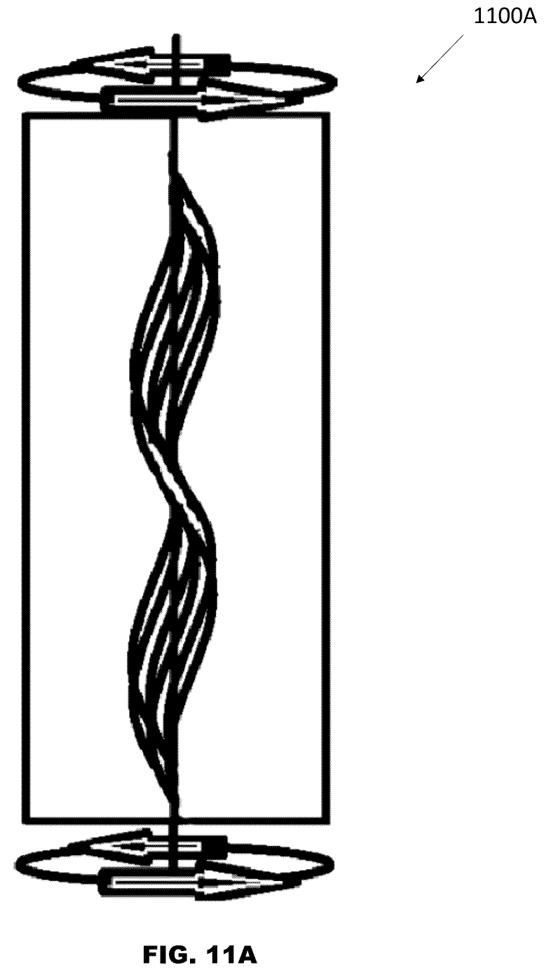

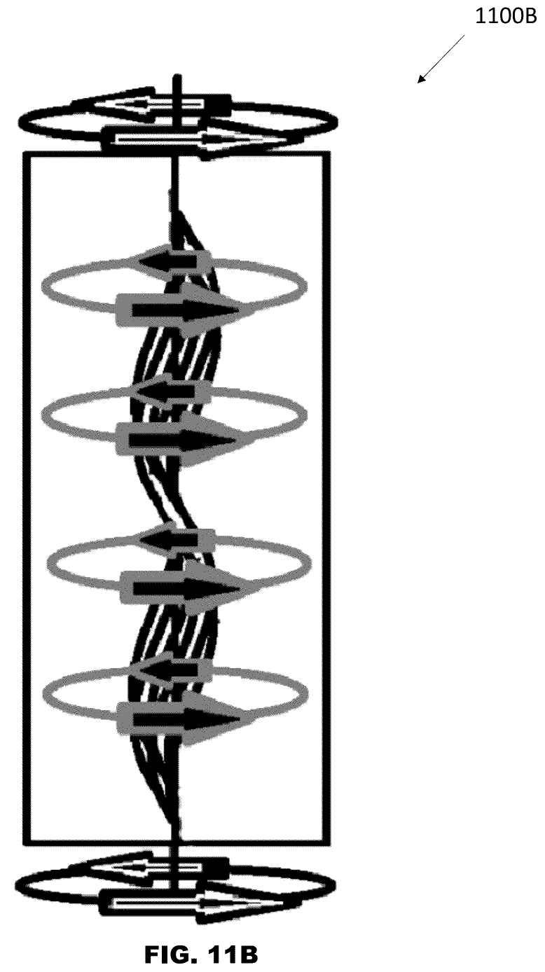

FIG. 11 may show energy extraction features 1100A. Additional attachments 1112 at shaft ends (FIG. 11A) may enable mechanical energy utilization. FIG. 11B may demonstrate energy conversion methods 1100B.

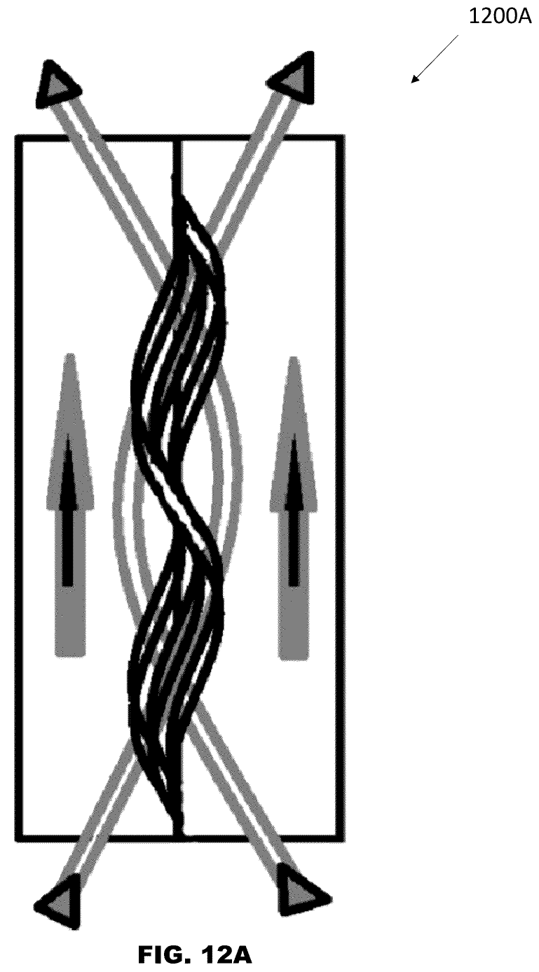

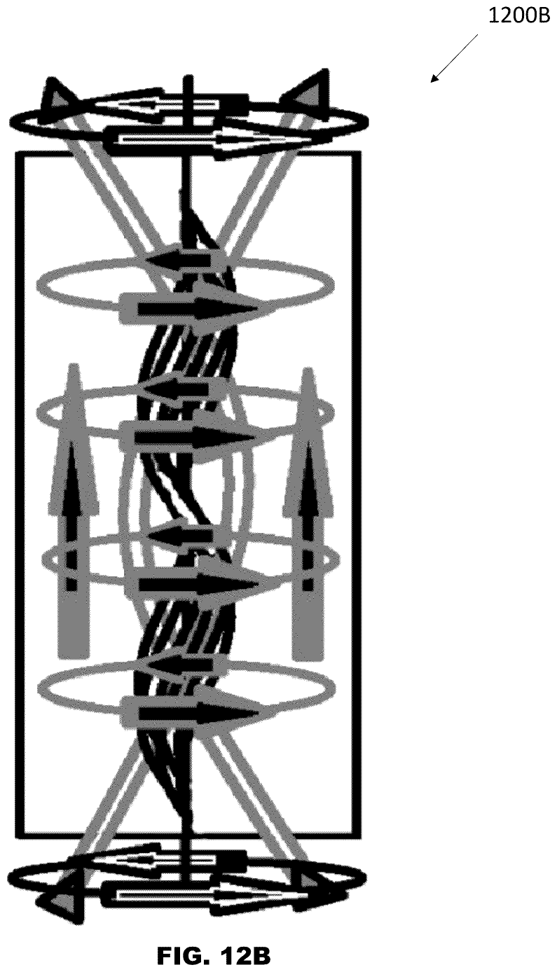

FIG. 12 may illustrate longitudinal flow effects 1200A. FIG. 12A may show spiral flow patterns 1222 along the shaft length 1224. FIG. 12B may demonstrate how multiple components may work together to produce accelerated shaft rotation.

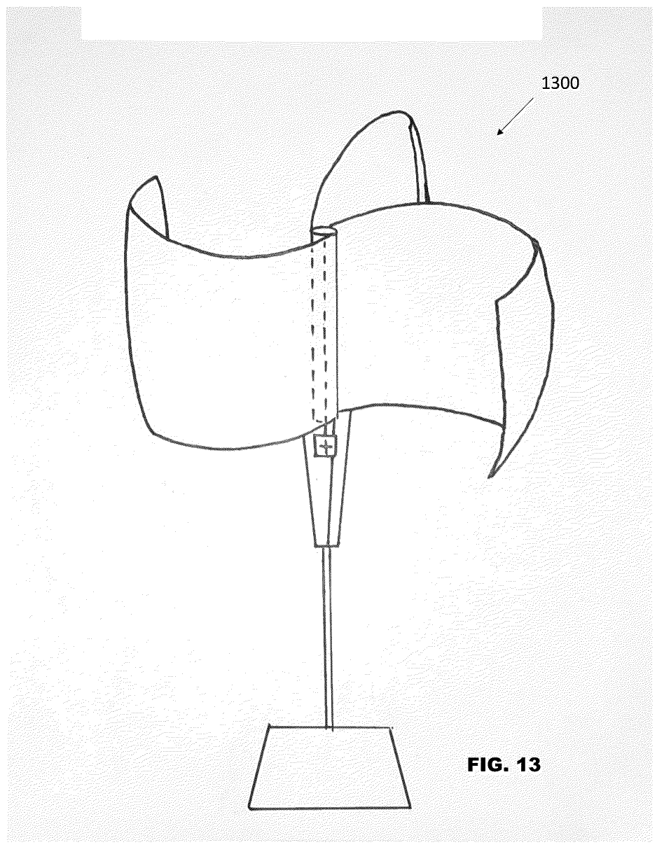

FIG. 13 may illustrate a mechanism 1300 for generating wind energy. The mechanism has the capacity for utilizing various designs in three-dimensional space through the chosen shapes of passive element structures, allowing for a variation in aesthetics that can foster a more seamless integration with the surrounding environment, ranging from geometric to organic (for example can be made to look like a tree, or a rock formation, etc). This is in contrast to current wind turbines which clearly stand out visually due to their shape and obvious motion when in operation.

The only moving part of the mechanism 1300 is shielded by a housing/cylinder, which is not visible or easily accessible from outside the mechanism 1300, thus alleviating concerns for disturbance and hazard to the surrounding wildlife (birds/bats) from moving parts.

Structural failures of the mechanism 1300 are less likely to result in tragic outcomes from collapse or ejected debris, as the mechanism's moving components are shielded and thus more likely to result in a self-contained break-down, providing a generally safer mechanism when compared to wind turbines currently in use.

Also, in terms of the anticipated longitudinal flow to be brought on by the spiral attachment to the central shaft 1332, it can be mentioned that this is similar in principle to the fluid motion produced by the well established “Archimedes screw”, with hopes of further adding credence to this part of the idea.

The system may be scaled across various sizes. The scaling may range from handheld devices to building-sized installations. The smaller scale implementations may serve personal energy needs. The intermediate sizes may support residential power requirements. The large scale versions may enable industrial energy generation.

In one or more embodiments, the passive and active elements may be manufactured from various materials. The passive element materials may include metal, plastic, wood, or fabric. The active element materials may be selected for low weight and high structural integrity. The cylindrical chamber materials may prioritize durability over weight considerations.

In one or more embodiments, the system may harness energy from different fluid types. The fluids may include air in wind energy applications. The fluids may include water in hydroelectric implementations. The system may operate in ocean currents. The system may function in river flows. The longitudinal flow characteristics may enhance overall system efficiency. The spiral attachments may promote fluid movement along the shaft length. The longitudinal flow may reduce resistance to shaft rotation. The reduced resistance may enable higher rotational speeds. The higher speeds may increase energy generation capacity. The system may achieve a positive feedback loop during operation. The feedback loop may result from increased fluid flow rates. The increased flow may create low pressure zones. The pressure differential may enhance fluid recruitment. The enhanced recruitment may accelerate shaft rotation. The acceleration may continue until reaching equilibrium.

In one or more embodiments, the cylindrical structure may include electromagnetic generators at one or both ends of the shaft. The electromagnetic generators may convert rotational motion of the shaft into electrical energy. The electrical energy may be used directly or stored in batteries for later use. The generators may be sized according to the anticipated rotational speeds and torque outputs of different scale implementations. The system may include mechanisms for mounting the shaft ends to allow free rotation while maintaining alignment. The mounting mechanisms may utilize precision bearings. The bearings may be selected based on anticipated rotational speeds and loads. The mounting mechanisms may be designed to minimize friction losses.

In one or more embodiments, the passive element surfaces may be manufactured using various materials depending on the implementation scale and environment. The materials may include metal alloys for durability in large installations. The materials may include reinforced plastics for lighter weight portable versions. The materials may include composite materials offering both strength and weight advantages.

In one or more embodiments, the spiral attachments on the shaft may be configured to optimize longitudinal flow characteristics. The spiral geometry may be customized based on anticipated fluid velocities and viscosities. The spiral attachments may be manufactured as integral components of the shaft. The spiral attachments may alternatively be separately manufactured and mechanically fastened to the shaft.

In one or more embodiments, the inlet vents in the cylindrical structure may be arranged to direct incoming fluid flow in an optimal direction relative to the spiral attachments. The vent angles may be customized based on computational fluid dynamics analysis. The vent sizes may be scaled proportionally with the overall system dimensions. The vent shapes may be optimized for minimal flow resistance.

In one or more embodiments, the longitudinal flow pathways may be designed to minimize turbulence and flow separation. The flow paths may maintain consistent cross-sectional areas. The flow paths may incorporate gradual transitions. The flow paths may avoid sharp corners or sudden expansions that could disrupt the desired flow patterns. The electromagnetic generators may be sized according to the anticipated rotational speeds and torque outputs of different scale implementations. The generators may convert the mechanical energy of shaft rotation into electrical energy. The electrical energy may be used directly or stored for later use. The electrical energy may be distributed through power transmission systems. The electrical energy may be converted to other forms of usable energy.

In one or more embodiments, the system may include mechanisms for mounting the shaft ends to allow free rotation while maintaining alignment. The mounting mechanisms may utilize precision bearings. The mounting mechanisms may be selected based on anticipated loads and speeds. The mounting mechanisms may incorporate seals to prevent fluid ingress. The mounting mechanisms may be designed for minimal friction losses.

In one or more embodiments, the spiral attachments on the shaft may be configured to optimize longitudinal flow characteristics. The spiral geometry may be customized based on anticipated fluid velocities. The spiral attachments may be manufactured as integral components. The spiral attachments may alternatively be separately manufactured and mechanically fastened. The spiral attachments may be optimized through computational fluid dynamics analysis.

In one or more embodiments, the inlet vents in the cylindrical structure may be arranged to direct incoming fluid flow optimally relative to the spiral attachments. The vent angles may be customized based on flow analysis. The vent sizes may be scaled proportionally with overall system dimensions. The vent shapes may be optimized for minimal flow resistance. The vent patterns may promote uniform flow distribution.

In one or more embodiments, the braking mechanism may include both mechanical and electromagnetic components. The braking components may be controlled manually or automatically. The braking mechanism may provide variable braking force. The braking mechanism may enable precise speed control. The braking mechanism may facilitate maintenance operations.

The system may include mechanisms for mounting the shaft ends to allow free rotation while maintaining alignment. The mounting mechanisms may utilize precision bearings. The mounting mechanisms may incorporate seals to prevent fluid ingress. The mounting mechanisms may be designed for minimal friction losses. The mounting mechanisms may be selected based on anticipated loads and speeds.

The spiral attachments on the shaft may be configured to optimize longitudinal flow characteristics. The spiral geometry may be customized based on anticipated fluid velocities. The spiral attachments may be manufactured as integral components. The spiral attachments may alternatively be separately manufactured and mechanically fastened. The spiral attachments may be optimized through computational fluid dynamics analysis.

The inlet vents in the cylindrical structure may be arranged to direct incoming fluid flow optimally relative to the spiral attachments. The vent angles may be customized based on flow analysis. The vent sizes may be scaled proportionally with overall system dimensions. The vent shapes may be optimized for minimal flow resistance. The vent patterns may promote uniform flow distribution.

The system may achieve self-sustaining operation through positive feedback mechanisms. The feedback loop may result from increased fluid flow rates within the active element, compared to ambient conditions. The increased flow may create low pressure zones. The pressure differential may enhance fluid recruitment. The enhanced recruitment may accelerate shaft rotation. The acceleration may continue until reaching equilibrium.

The system may include mechanisms for mounting the shaft ends to allow free rotation while maintaining alignment. The mounting mechanisms may utilize precision bearings. The bearings may be selected based on anticipated rotational speeds and loads. The mounting mechanisms may be designed to minimize friction losses.

### Conclusion

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims. While illustrative embodiments of the invention have been shown and described, variations and alternative embodiments may occur to those skilled in the art. Such variations and alternative embodiments may be made without departing from the scope of the invention as defined in the claims. As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . ”

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

It should be understood that the above-described embodiments are illustrative of only a few of the possible specific embodiments which can represent applications of the principles of the present disclosure. Numerous and varied other arrangements can be readily devised by those skilled in the art without departing from the spirit and scope of the disclosure. While specific embodiments of the invention have been described and illustrated, such embodiments should be considered illustrative of the invention only and not as limiting the invention as construed in accordance with the accompanying claims.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. It is to be understood that the foregoing description is not intended to limit the scope of the present disclosure. The present disclosure contemplates numerous variations, modifications, and adaptations that will become apparent to those skilled in the art upon reading and understanding the foregoing description. The scope of the present disclosure is defined by the appended claims and their legal equivalents.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A fluid energy generation apparatus comprising:
a passive element comprising at least one fluid collection surface configured to collect and direct fluid flow along a gradually narrowing path to create an accelerated fluid flow;
an active element comprising:
a rotatable shaft;
a cylindrical chamber surrounding the rotatable shaft;
a plurality of inlet vents formed in the cylindrical chamber and angled to direct the accelerated fluid flow in a unidirectional pattern around the rotatable shaft; and
at least one attachment coupled to the rotatable shaft and configured to convert kinetic energy from the accelerated fluid flow into rotational motion of the shaft;
wherein the passive element is maintained substantially stationary relative to the active element.

2. The apparatus of claim 1, wherein the at least one fluid collection surface comprises multiple surfaces arranged to collect fluid flow from multiple directions around the active element.

3. The apparatus of claim 1, wherein the at least one fluid collection surface comprises a spiral surface configured to create a funneling effect to accelerate the fluid flow.

4. The apparatus of claim 1, wherein the at least one attachment comprises a spiral surface extending radially from the rotatable shaft.

5. The apparatus of claim 4, wherein the spiral surface is configured to direct the fluid flow longitudinally along the rotatable shaft to create a low-pressure system within the cylindrical chamber.

6. The apparatus of claim 1, further comprising:
a mounting structure configured to maintain the passive element in a substantially stationary position relative to the active element; and
bearings coupled between the rotatable shaft and the cylindrical chamber to enable low-friction rotation.

7. The apparatus of claim 1, further comprising:
an energy conversion mechanism coupled to the rotatable shaft and configured to convert the rotational motion into electrical energy; and
a braking system configured to control rotation speed of the shaft.

8. A method of generating energy from fluid flow comprising:
collecting fluid flow using at least one stationary collection surface;
directing the collected fluid flow along a gradually narrowing path to create an accelerated fluid flow;
receiving the accelerated fluid flow through angled inlet vents of a cylindrical chamber;
directing the accelerated fluid flow in a unidirectional pattern around a rotatable shaft within the cylindrical chamber;
converting kinetic energy from the accelerated fluid flow into rotational motion of the shaft using at least one attachment coupled to the shaft; and
maintaining the collection surface substantially stationary relative to the shaft during operation.

9. The method of claim 8, further comprising:
collecting fluid flow simultaneously from multiple directions using multiple collection surfaces arranged around the cylindrical chamber; and
combining the collected fluid flows into the accelerated fluid flow directed to the inlet vents.

10. The method of claim 8, further comprising:
directing the accelerated fluid flow longitudinally along the shaft using a spiral attachment surface to create a low-pressure system within the cylindrical chamber; and
generating a positive feedback loop to enhance fluid recruitment through the collection surface.

11. A fluid energy generation system comprising:
a passive fluid collection assembly comprising:
a plurality of converging surfaces arranged radially around a central axis;
wherein each converging surface extends from a wider fluid intake end to a narrower fluid output end;
wherein the converging surfaces are configured to accelerate collected fluid flow toward the central axis;
an active energy conversion assembly positioned along the central axis comprising:
a rotatable shaft extending along the central axis;
a cylindrical housing surrounding the rotatable shaft;
a plurality of angled inlet ports formed in the cylindrical housing;
wherein the inlet ports are configured to direct accelerated fluid from the converging surfaces tangentially around the rotatable shaft;
a spiral blade assembly coupled to and extending radially from the rotatable shaft;
wherein the spiral blade assembly is configured to convert fluid kinetic energy into shaft rotation;
wherein the passive fluid collection assembly maintains a fixed position relative to the active energy conversion assembly during operation.

12. The system of claim 11, wherein the spiral blade assembly comprises:
a continuous helical surface extending along a length of the rotatable shaft;
wherein the helical surface is configured to direct fluid flow longitudinally along the shaft while maintaining tangential flow around the shaft.

13. The system of claim 11, further comprising:
an electromagnetic generator coupled to the rotatable shaft;
wherein the electromagnetic generator is configured to convert shaft rotation into electrical energy.

14. The system of claim 11, wherein:
the converging surfaces are arranged symmetrically around the central axis to enable omnidirectional fluid collection;
the converging surfaces comprise curved portions that smoothly transition fluid flow from radial to tangential directions.

15. The system of claim 11, further comprising:
a braking mechanism coupled to the rotatable shaft;
a control system configured to:
monitor rotation speed of the shaft;
activate the braking mechanism when rotation speed exceeds a threshold;
deactivate the braking mechanism when rotation speed falls below the threshold.

16. A fluid energy generation device comprising:
a passive fluid collector comprising:
a plurality of curved surfaces extending from a first diameter to a second smaller diameter;
wherein the curved surfaces are configured to create a funneling effect to accelerate fluid flow;
an active energy converter comprising:
an elongated rotatable shaft;
a housing surrounding the rotatable shaft;
a plurality of fluid inlets formed in the housing;
wherein the fluid inlets are oriented to direct accelerated fluid flow from the curved surfaces in a uniform direction around the rotatable shaft;
a spiral attachment coupled to the rotatable shaft;
wherein the spiral attachment is configured to:
convert fluid kinetic energy to rotational motion; and
direct fluid flow longitudinally along the shaft.

17. The device of claim 16, wherein:
the curved surfaces are arranged symmetrically around the housing to enable fluid collection from multiple directions;
the curved surfaces comprise smoothly transitioning portions that redirect fluid flow from radial to tangential directions.

18. The device of claim 16, wherein the spiral attachment comprises:
a continuous helical blade extending along a length of the rotatable shaft;
wherein the helical blade is configured to:
maintain tangential fluid flow around the shaft while directing fluid longitudinally; and
create a pressure differential between ends of the housing.

19. The device of claim 16, further comprising:
a mounting structure configured to maintain the curved surfaces in fixed positions relative to the housing;
bearings positioned between the rotatable shaft and the housing to enable low-friction rotation.

20. The device of claim 16, further comprising:
an electromagnetic generator coupled to the rotatable shaft;
a braking system configured to regulate shaft rotation speed;
wherein the electromagnetic generator is configured to convert the rotational motion to electrical energy.
